(19) United States
(12) Patent Application Publication
(10) Pub. No.: US 2025/0330053 A1
(43) Pub. Date: Oct. 23, 2025

(54) PERMANENT MAGNET MOTOR BASED ON MAGNETIC FIELD MODULATION PRINCIPLE AND OPTIMIZATION SYSTEM

(71) Applicant: ZHONGYUAN UNIVERSITY OF TECHNOLOGY, Zhengzhou (CN)

(72) Inventors: Boyang QU, Zhengzhou (CN); Fangfang BIAN, Zhengzhou (CN); Jie SU, Zhengzhou (CN); Hui YANG, Zhengzhou (CN); Limin ZHANG, Zhengzhou (CN); Baihao QIAO, Zhengzhou (CN); Xuzhao CHAI, Zhengzhou (CN)

(73) Assignee: ZHONGYUAN UNIVERSITY OF TECHNOLOGY, Zhengzhou (CN)

(21) Appl. No.: 19/035,957

(22) Filed: Jan. 24, 2025

(30) Foreign Application Priority Data
Apr. 19, 2024 (CN) 202410477377.X

(51) Int. Cl. H02K 1/276; G06F 30/27; G06F 117/12; G06F 119/14; H02K 1/16; H02K 1/2713

(52) U.S. Cl. CPC H02K 1/276; G06F 30/27; H02K 1/16; H02K 1/2713; G06F 2117/12; G06F 2119/14; H02K 2213/03

(57) ABSTRACT

Embodiments of the present disclosure provides a permanent magnet motor based on magnetic field modulation principle and an optimization system. The permanent magnet motor includes a stator and a rotor, wherein the rotor is disposed on an inner side of the stator, the stator is rotationally connected to the rotor, at least one armature tooth is disposed on the inner side of the stator, a three-phase single layer centralized winding is disposed on the armature tooth, at least one rotor slot wedge is disposed on the outer side of the rotor, rotor teeth are disposed on a top of the rotor slot wedge, rotor slots are disposed between the rotor teeth, a permanent magnet set is disposed in each of the rotor slots, at least two stator modulating teeth are disposed on a top of the armature tooth, and a stator slot is disposed between adjacent stator modulating teeth.

### CROSS REFERENCE TO RELATED APPLICATIONS

This application claims priority to Chinese application No. 202410477377.X, filed on Apr. 19, 2024, the entire contents of which are incorporated herein by reference.

### TECHNICAL FIELD

The present disclosure relates to the technical field of permanent magnet motors, and in particular, to a permanent magnet motor based on magnetic field modulation principle and an optimization system.

### BACKGROUND

A permanent magnet motor based on magnetic field modulation principle has the advantages of high torque density and low torque pulsation, which has high research and application value in the field of transportation. However, how to fully utilize the features of the permanent magnet motor in the design stage of motors, and how to reasonably allocate the spatial locations of armature winding and magnetic permanent magnet units while achieving high torque density are urgent problems that need to be solved.

For example, the specification of the application No. 202110369032.9 discloses a stator partitioned hybrid excitation motor having a built-in regulating ring structure, which realizes that the output torque can be adjusted upward and downward in accordance with the needs of the application, and has superior flexibility. The motor adopts a double stator structure, which provides good magnetization regulation; however, due to the presence of a stator yoke portion within the motor, the permanent magnet magnetic field has a high amount of leakage as it passes through the stator structure, which reduces the utilization rate of the permanent magnet magnetic field.

The specification of the application No. 202310686447.8 discloses a multi-objective optimization method applicable to a multi-parameter coupled permanent magnet vernier rimmed propulsion motor, including: establishing an unloaded model of the motor; taking an average torque and a torque pulsation as optimization objects; determining value ranges of structural parameters affecting the average torque and the torque pulsation; bringing the value ranges of the structural parameters back to the unloaded model of the motor and checking whether meeting design requirements; adopting the optimization Latin superlattice manner to supplement a certain amount of sample data within a sparse sample range; sorting structural parameters of the motor in terms of sensitivities and hierarchical processing; finding a global optimal solution and adjusting the structural parameters that are weakly optimized. But since the motor structure proposed in the specification differs greatly from that proposed in the present disclosure, and the optimization processes for the structural parameters also differ, the methods proposed in the specification are not applicable to the present disclosure.

### SUMMARY

Aiming at the technical problem that the torque density of a magnetic field modulated motor is limited, this specification proposes a permanent magnet motor based on magnetic field modulation principle and an optimization system. The permanent magnet motor has a compact structure, and the optimization system may be introduced to effectively reduce the optimization workload and improve the optimization accuracy.

In order to achieve the above purpose, one of the embodiments of the present disclosure provides a permanent magnet motor based on magnetic field modulation principle, comprising a stator and a rotor, wherein the rotor is disposed on an inner side of the stator, the stator is rotationally connected to the rotor, at least one armature tooth is disposed on the inner side of the stator, a three-phase single layer centralized winding is disposed on the at least one armature tooth, at least one rotor slot wedge is disposed on the outer side of the rotor, rotor teeth are disposed on a top of the at least one rotor slot wedge, rotor slots are disposed between the rotor teeth, a permanent magnet set is disposed in each of the rotor slots, at least two stator modulating teeth are disposed on a top of the armature tooth, and a stator slot is disposed between adjacent stator modulating teeth in the at least two stator modulating teeth.

One of the embodiments of the present disclosure provides an optimization system, comprising a permanent magnet motor and a processor, the permanent magnet motor being communicatively connected to the processor; wherein: the permanent magnet motor includes a stator and a rotor, wherein the rotor is disposed on an inner side of the stator, the stator is rotationally connected to the rotor, at least one armature tooth is disposed on the inner side of the stator, a three-phase single layer centralized winding is disposed on the at least one armature tooth, at least one rotor slot wedge is disposed on the outer side of the rotor, rotor teeth are disposed on a top of the at least one rotor slot wedge, rotor slots are disposed between the rotor teeth, a permanent magnet set is disposed in each of the rotor slots, at least two stator modulating teeth are disposed on a top of the armature tooth, and a stator slot is disposed between adjacent stator modulating teeth in the at least two stator modulating teeth; and the processor is configured to: select optimization objects and design variables based on the permanent magnet motor; obtain design variables of a first sensitivity layer and design variables of a second sensitivity layer by stratifying the design variables using a composite sensitivity; wherein each of the design variables of the first sensitivity layer has a composite sensitivity greater than or equal to a stratification threshold, and each of the design variables of the second sensitivity layer has a composite sensitivity less than the stratification threshold; and obtain design variables corresponding to an optimal optimization object by processing an approximate model of the first sensitivity layer using a raccoon algorithm.

### BRIEF DESCRIPTION OF THE DRAWINGS

In order to more clearly illustrate the technical solutions in the embodiments or prior art of the present disclosure, the accompanying drawings that need to be used in the descriptions of the embodiments or prior art will be briefly described below, and it will be obvious that the accompanying drawings in the following descriptions are only some of the embodiments of the present disclosure. It is obvious that the drawings described below are only some embodiments of the present disclosure, and for those of ordinary skill in the art, other drawings can be obtained based on these drawings without creative labor.

FIG. 1 is a schematic diagram of a structure of a permanent magnet motor based on magnetic field modulation principle according to some embodiments of the present disclosure;

FIG. 2 is an enlarged exemplary schematic diagram of a rotor slot wedge according to some embodiments of the present disclosure;

FIG. 3 is an exemplary flowchart of a process for obtaining design variables corresponding to an optimal optimization object according to some embodiments of the present disclosure;

FIG. 4 is a flowchart of an exemplary process for processing an approximate model of a first sensitivity layer using a raccoon algorithm according to some embodiments of the present disclosure;

FIG. 5 is an exemplary schematic diagram of stratifying design variables according to some embodiments of the present disclosure;

FIG. 6 is a schematic diagram of a structure of a temperature sensor and a temperature control unit according to some embodiments of the present disclosure;

FIG. 7 is a comparative waveform graph of a motor torque according to some embodiments of the present disclosure;

FIG. 8 is a comparative waveform graph of a no-load back electromotive force of a motor according to some embodiments of the present disclosure;

FIG. 9 is a comparative waveform graph of a torque of a magnet-concentrating permanent magnet unit according to some embodiments of the present disclosure;

Attachment markings: in the drawings, 1 is a stator, 2 is a rotor, 3 is an armature tooth, 4 is stator modulating teeth, 5 is a three-phase single layer centralized winding, 6 is a radial permanent magnet, 7 is spoke permanent magnets, 8 is rotor teeth, 9 is a temperature control unit, and 10 is a temperature sensor.

### DETAILED DESCRIPTION

The technical solutions in the embodiments of the present disclosure will be clearly and completely described below in conjunction with the accompanying drawings in the embodiments of the present disclosure, and it is clear that the embodiments described are only a part of the embodiments of the present disclosure, and not the whole of the embodiments. Based on the embodiments in the present disclosure, all other embodiments obtained by a person of ordinary skill in the art without creative labor fall within the scope of protection of the present disclosure.

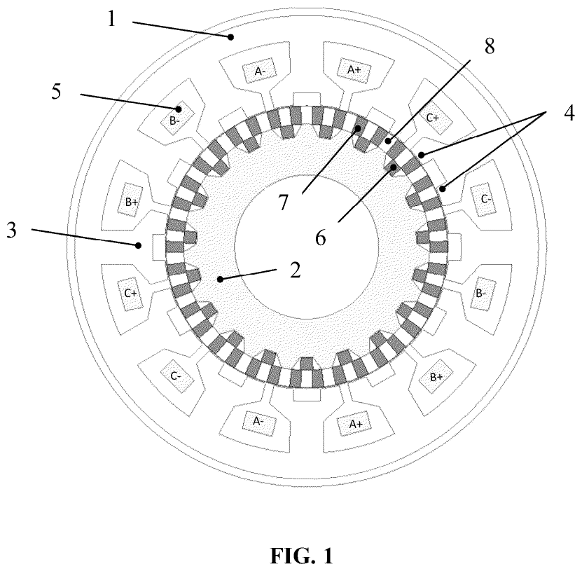

FIG. 1 is a schematic diagram of a structure of a permanent magnet motor based on magnetic field modulation principle according to some embodiments of the present disclosure.

In some embodiments, as shown in FIG. 1, a permanent magnet motor based on magnetic field modulation principle 100 includes a stator 1 and a rotor 2, wherein the rotor 2 is disposed on an inner side of the stator 1, the stator 1 is rotationally connected to the rotor 2, at least one armature tooth 3 is disposed on the inner side of the stator 1, a three-phase single layer centralized winding 5 is disposed on the at least one armature tooth 3, at least one rotor slot wedge is disposed on the outer side of the rotor 2, rotor teeth 8 are disposed on a top of the at least one rotor slot wedge, rotor slots are disposed between the rotor teeth 8, a permanent magnet set is disposed in each of the rotor slots, at least two stator modulating teeth 4 are disposed on a top of the armature tooth 3, and a stator slot is disposed between adjacent stator modulating teeth in the at least two stator modulating teeth 4.

The permanent magnet motor based on magnetic field modulation principle (also referred to as the permanent magnet motor or a motor) is a motor that uses magnetic field modulation technology to improve the performance of the permanent magnet motor.

In some embodiments, the stator is rotationally connected to the rotor.

For example, rotating connections (also referred to as movable connections) may include, but are not limited to, connections between bearings and a shaft, etc.

In some embodiments, one or more of the armature teeth 3 are uniformly disposed on the inner side of the stator 1 as shown in FIG. 1.

In some embodiments, the permanent magnet motor ensures that the magnetic field generated by the three-phase single layer centralized winding interacts efficiently with the magnetic field of the rotor through the armature tooth, thereby generating a torque in the permanent magnet motor.

In some embodiments, the three-phase single layer centralized windings 5 are spaced apart on the at least one armature tooth 3. Spacing means that the adjacent three-phase single layer centralized windings are equally spaced.

In some embodiments, the three-phase single layer centralized winding generates a rotating magnetic field when the permanent magnet motor is energized, thereby converting electrical energy to mechanical energy.

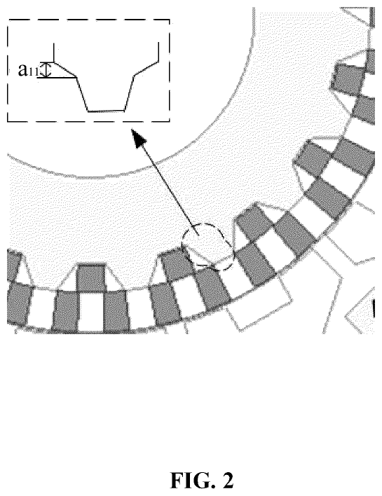

FIG. 2 is an enlarged exemplary schematic diagram of a rotor slot wedge according to some embodiments of the present disclosure. The rotor slot wedge is shown in FIG. 2.

In some embodiments, the rotor 2 and the stator 1 are two rings set concentrically, with the rotor 2 being set inside the stator 1. The stator 1 and the rotor 2 are made of silicon steel sheets laminated together, which have the advantages of high permeability and low hysteresis loss, thereby making air-gap magnetization of the permanent magnet motor effectively enhanced and reducing eddy current loss.

In some embodiments, a gap is provided between the adjacent armature teeth 3, and the three-phase single layer centralized winding 5 is wound across the gap on the armature tooth 3. If each three-phase single layer centralized winding 5 is provided on the same armature tooth 3, there is no three-phase single layer centralized winding on adjacent armature teeth 3 of that armature tooth 3.

In some embodiments, the three-phase single layer centralized windings on two radially opposite armature teeth 3 are connected in series to form a single phase, and the three-phase single layer centralized windings 5 are distributed on the armature teeth 3 in a clockwise direction of A, B, C, A, B, C. Each phase of the single layer centralized winding is independent of each other, and a coil of the single-layer centralized winding has a simpler process, and there is no interlayer insulation, which allows for a high utilization rate of the gap.

In some embodiments, the at least one armature tooth 3 is provided with at least two stator modulating teeth 4 at the top, and a stator slot is provided between two adjacent stator modulating teeth 4. The structure of the stator modulating teeth provides better magnetic field modulation, a count of the modulating teeth 4 at the top of each armature tooth 3 is consistent, and the shape of the modulating teeth is not unique.

In some embodiments, in order to generate a stable electromagnetic torque, a count of pole pairs of a permanent magnet set, a count of pole pairs of an armature winding, and a count of the stator modulating teeth satisfy a predetermined correspondence.

In some embodiments, the count of pole pairs of the permanent magnet set Pₚₘ, the count of pole pairs of the armature winding Pₐ, and the count of the stator modulating teeth Nₛ may satisfy a following preset correspondence: Pₐ=|Pₚₘ−Nₛ|.

The count of pole pairs of the permanent magnet set is a count of magnetic pole pairs formed by the permanent magnet set on the rotor.

The count of pole pairs of the armature winding is a count of magnetic pole pairs formed by the armature winding on the stator.

The count of stator modulating teeth is a count of teeth on the stator used to modulate the magnetic field.

In some embodiments, the count of pole pairs of the permanent magnet set, the count of pole pairs of the armature winding, and the count of the stator modulating teeth are experimentally determined by a person skilled in the art based on a predetermined correspondence.

By ensuring that the count of pole pairs of the armature winding, the count of pole pairs of the permanent magnet set, and the count of teeth of the stator modulating teeth satisfy the preset correspondence, the permanent magnet motor generates a more stable and controllable electromagnetic torque, which contributes to improving the smoothness and efficiency of operation of the permanent magnet motor.

In some embodiments, the permanent magnet set includes spoke permanent magnets and spoke permanent magnets. A count of spoke permanent magnets and a count of spoke permanent magnets in the permanent magnet set are predetermined based on actual needs.

In some embodiments, as shown in FIG. 1, the permanent magnet set includes a radial permanent magnet 6 and two spoke permanent magnets 7, the radial permanent magnet 6 being disposed at the bottom of the rotor slot, and the spoke permanent magnets 7 being disposed on both sides of the radial permanent magnet 6, with the spoke permanent magnets 7 being fixedly connected to a side wall of the rotor slot. The spoke permanent magnets 7 are tangentially magnetized permanent magnets, and adjacent spoke permanent magnets 7 are magnetized in opposite directions. The radial permanent magnet 6 is an axially magnetized permanent magnet.

The radial permanent magnet is a permanent magnet whose magnetization direction is tangential. The spoke permanent magnet is a permanent magnet whose magnetization direction is towards a side of a rotor axis.

Tangential means that a direction of magnetization of the spoke permanent magnet is along a tangential direction of a circumference of the rotor.

Axial means that a direction of magnetization of the radial permanent magnet is along an axial direction of the permanent magnet motor.

In some embodiments, the material of the radial permanent magnet 6 and the spoke permanent magnet 7 includes a rectangular neodymium-iron-boron permanent magnet material, a samarium cobalt magnet material, an aluminum-nickel-cobalt material, or the like.

By combining the radial permanent magnet and spoke permanent magnets, a more effective magnetic field modulation is realized, which helps to improve the efficiency and power density of the permanent magnet motor. Since adjacent spoke permanent magnets are magnetized in opposite directions, it helps to reduce torque fluctuations and provide smoother running performance. In addition, the radial permanent magnet and spoke permanent magnets work together to produce a more uniform flux distribution and reduce flux distortion.

A goal of high torque density and low torque pulsation in the permanent magnet motor based on magnetic field modulation principle is achieved by combining the permanent magnet motor with the modulation effect and utilizing polymagnetic permanent magnet units. In addition, by reasonably allocating the spatial locations of the armature tooth, the three-phase single layer centralized winding, and the permanent magnet set, the high torque density is achieved while making full use of the space of the permanent magnet motor, and at the same time, the present disclosure realizes the high torque density while utilizing the three-phase single layer centralized winding. The windings are independent of each other, and the coil of the three-phase single-layer winding has a simpler process, while there is no interlayer insulation, making the utilization rate of the gap high.

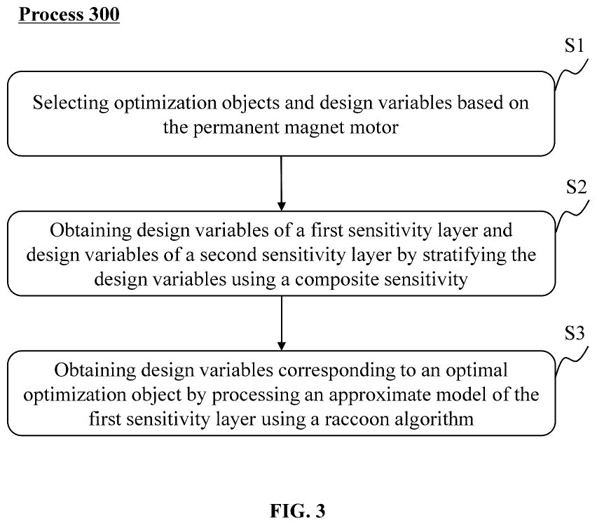

FIG. 3 is an exemplary flowchart of a process for obtaining design variables corresponding to an optimal optimization object according to some embodiments of the present disclosure. In some embodiments, process 300 includes the following steps and is executed by a processor.

In some embodiments, for the permanent magnet motor based on magnetic field modulation principle, the present disclosure proposes an optimization system, with three motor performance parameters, namely, average torque, torque pulsation, and cogging torque, as the optimization objects, and optimization is performed by a raccoon algorithm to find an optimal structural parameter combination to realize the requirement of large torque and low pulsation of the permanent magnet motor.

In some embodiments, the optimization system includes the permanent magnet motor and the processor, the permanent magnet motor being communicatively connected to the processor.

More about the permanent magnet motor can be found in FIG. 1.

The processor may process information and/or data related to the optimization system. In some embodiments, the processor includes a central processing unit (CPU), an application-specific integrated circuit (ASIC), etc., or any combination thereof.

In some embodiments, the processor selects the optimization objects and design variables based on the permanent magnet motor. The processor then stratifies the design variables using a composite sensitivity to obtain design variables for a first sensitivity layer and design variables for a second sensitivity layer. The processor obtains the design variables corresponding to the optimal optimization object by processing an approximate model of the first sensitivity layer using the raccoon algorithm.

S1: selecting optimization objects and design variables based on the permanent magnet motor.

The optimization objects are parameters that are expected to improve the performance associated with the permanent magnet motors.

In some embodiments, the optimization objects include an average torque b₁, a torque pulsation b₂, a cogging torque b₃, etc., which are not limited here.

The average torque is an average output torque produced by the permanent magnet motor during a normal operation.

The torque pulsation is a degree of torque fluctuation of the permanent magnet motor during an operation.

The cogging torque is a torque generated by an interaction between a permanent magnet and a stator core.

In some embodiments, the average torque, the torque pulsation, and the cogging torque are set by a skilled professional or by system default.

In some embodiments, optimizing the average torque of the permanent magnet motor ensures that it meets power requirements and improves performance and efficiency. Reducing the torque pulsations can help reduce noise and vibration during the operation of the permanent magnet motor and enhance reliability. At the same time, optimizing the cogging torque enhances the smoothness of the motor's operation, further reduces vibration and noise, and improves overall efficiency.

The design variables are parameters that are tuned during the modulation of the permanent magnet motor. The selection and combination of the design variables may determine the final performance of the permanent magnet motor.

In some embodiments, the design variables include at least one of a ratio a₁ of an opening height of the stator slot to a height of the stator slot, a ratio a₂ of a height of each of the stator modulating teeth to the height of the stator slot, a ratio a₃ of an opening width of the stator slot to a width of the stator slot, a ratio a₄ of a width of each of the stator modulating teeth to the width of the stator slot, an opening width a₅ of each of the rotor slots, a pole arc coefficient a₆ of the radial permanent magnet, a height a₇ of the radial permanent magnet, a pole arc coefficient a₈ of each of the spoke permanent magnets, a height a₉ of each of the spoke permanent magnets, an opening height a₁₀ the rotor slot, a height a₁₁ of the rotor slot wedge, and a ratio a₁₂ of the opening width of the rotor slot to a bottom width of the rotor slot.

The pole arc coefficient of the radial permanent magnet may be determined in a variety of ways, such as based on a ratio of a pole arc width to a pole pitch of the radial permanent magnet. The pole arc coefficient of the radial permanent magnet is similar to the pole arc coefficient of the radial permanent magnet.

By choosing the above design variables and optimization objects, it helps to accurately control the electromagnetic features of the permanent magnet motor, thus increasing the average torque and ensuring that the permanent magnet motor has a sufficient load capacity while reducing the torque pulsation and cogging torque, which makes the permanent magnet motor run more smoothly.

In some embodiments, the selection of the optimization objects and the design variables are determined by a technical professional based on the permanent magnet motor through a priori experience.

S2: obtaining the design variables of the first sensitivity layer and the design variables of the second sensitivity layer by stratifying the design variables using the composite sensitivity.

The composite sensitivity is a sensitivity of a single design variable to all optimization objects.

In some embodiments of the present disclosure, the processor determines the sensitivity based on the optimization objects and the design variables; and determine the composite sensitivity based on the sensitivity, the optimization objects, and weighting coefficients of the optimization objects.

The sensitivity is a sensitivity of a single design variable to a single optimization objects.

In some embodiments of the present disclosure, the processor determines the sensitivity in a variety of ways based on the optimization objects and the design variables. For example, the processor determines the sensitivity based on the optimization objects, the design variables, by the equation (1) as follows:

$$Sj ( {a}_{i} ) = \frac{\partial {b}_{j}}{\partial {a}_{i}} {\vert}_{NOP} \frac{{a}_{i}}{{b}_{j}} \approx \frac{Percentage change of {b}_{j}}{Percentage change of {a}_{i}} = \frac{Δ {b}_{j} / {b}_{j}}{Δ {a}_{i} / {a}_{i}} \qquad ( 1 )$$

wherein, bⱼ denotes a jth optimization object, aᵢ is an ith design variable, Sⱼ is the sensitivity, Δbⱼ is a change amount of the j optimization objects, Δaᵢ is a change amount of the ith design variable, NOP is a partial derivative of the jth optimization object in the ith design variable, i=1, 2 . . . 12, j=1, 2, 3.

The processor also determines the sensitivity in any other feasible way, without limitation here.

In some embodiments of the present disclosure, the three optimization objects are considered together, and the weighting coefficients are used to measure the level of importance of each design variable. Merely by way of example, the processor determines the composite sensitivity based on the sensitivity, the weighting coefficients, and the optimization objects by using equation (2) as follows:

$${S}_{c o m} ( {a}_{i} ) = {\sum }_{j = 1 , 2 , 3} {w}_{j} \vert {S}_{j} ( {a}_{i} ) \vert ; \qquad ( 2 )$$

where, S_{com}(aᵢ) is a composite sensitivity of the ith design variable to the jth optimization object, and wⱼ is a weighting coefficient of the jth optimization object. The weighting coefficients are pre-set by professional and technical personnel, and merely by way of example, w₁, w₂ and w₃ are 0.5, 0.25 and 0.25, respectively.

In some embodiments of the present disclosure, the processor obtains load feature data for the optimization objects. The processor determines a correlation coefficient between the optimization objects and the design variables based on the load feature data for the optimization objects. The processor determines the weighting coefficients for the optimization objects based on the correlation coefficients.

The load feature data is actual values of the optimization objects for the permanent magnet motor under load. For example, the load feature data includes, but is not limited to, an actual average torque, an actual torque pulsation, an actual cogging torque, or the like.

In some embodiments of the present disclosure, the load feature data also includes actual values of the optimization objects for a plurality of different permanent magnet motors under load.

In some embodiments of the present disclosure, the load feature data for each permanent magnet motor includes actual values of the optimization objects for that permanent magnet motor under load at a plurality of time points.

In some embodiments of the present disclosure, the design variables selected by different permanent magnet motors are the same or different.

In some embodiments of the present disclosure, the processor may collect and store the load feature data via specialized measurement equipment during actual use. The processor may also collect and store the load feature data via specialized measurement equipment in experimental simulation application scenarios.

In some embodiments of the present disclosure, the processor also combines the two approaches described above to simultaneously collect and store the load feature data. For example, the processor first collects the load feature data during actual use, and in response to an amount of the load feature data being insufficient or uneven, performs supplemental collection in experimental simulation application scenarios.

Unevenness refers to unevenness of a distribution of the load feature data.

The correlation coefficient is an index used to characterize a degree of linear correlation between the optimization objects and the design variables.

In some embodiments of the present disclosure, the processor determines the correlation coefficient between the optimization objects and the design variables based on the optimization objects load feature data of the optimization objects in plurality of ways. For example, the processor determines the correlation coefficient based on the following operations.

S21, the processor calculates average feature data of each permanent magnet motor. For example, the load feature data collected at the plurality of time points is averaged.

The average feature data includes, but is not limited to, an average torque Xₖb₁, an average torque pulsation Xₖb₂, and an average cogging torque Xₖb₃. k denotes a kth permanent magnet motor.

S22, a correlation coefficient is calculated between each of pieces of the average feature data and each of the design variables of k the permanent magnet motors feature. For example, the processor calculates the correlation coefficient between each of pieces of the average feature data and each of the design variables based on each of pieces of the average feature data and each of the design variables of k permanent magnet motors through a Pearson correlation coefficient equation. For example, the correlation coefficient of the average torque X₁b₁ to the design variable a₁ (the ratio of the opening height of the stator slot to the height of the stator slot) in the permanent magnet motor 1 is r1, the correlation coefficient of the average torque X₂b₁ to the design variable a₁ in the permanent magnet motor 2 is r2, . . . and the correlation coefficient of the average torque Xₖb₁ to the design variable in the permanent magnet motor k is rk. Then the processor determines the average of the foregoing r1 to rk as the correlation coefficient between the average torque b₁ and the design variable a₁.

S23, the processor calculates correlation coefficients between each optimization object and all design variables. For example, the processor determines the average of the correlation coefficients between each of pieces of the average feature data and all design variables in S22 as the correlation coefficient between the optimization objects and the design variables corresponding to that average feature data.

In some embodiments, the processor determines the weighting coefficients based on an absolute value of the correlation coefficient. For example, the closer the absolute value of the correlation coefficient is to 1, the more easily the optimization objects are affected by changes in the design variables optimization objects, and the higher the weighting coefficients for the optimization objects.

The processor can accurately quantify the relationship between the optimization objects and design parameters by calculating the correlation coefficient between the average feature data of the permanent magnet motor and each design variable. The weight of the optimization objects are determined based on the absolute value of the correlation coefficient, ensuring that the adjustment of the design variables can be more focused on the parameters that have a greater impact on the performance of the permanent magnet motor, thereby improving the performance of the permanent magnet motor.

In some embodiments, the designed permanent magnet motor has a large average torque in practical applications, on which the smaller the torque pulsation and the smaller the cogging torque, the better.

In some embodiments, the design variables of the first sensitivity layer (also referred to as a strong sensitivity layer) are design variables whose composite sensitivity is greater than or equal to a stratification threshold. The design variables in the second sensitivity layer (also referred to as a weak sensitivity layer) are design variables whose composite sensitivity is less than the stratification threshold.

The stratification threshold is obtained by default by a skilled professional. For example, the stratification threshold is 0.06, or the like.

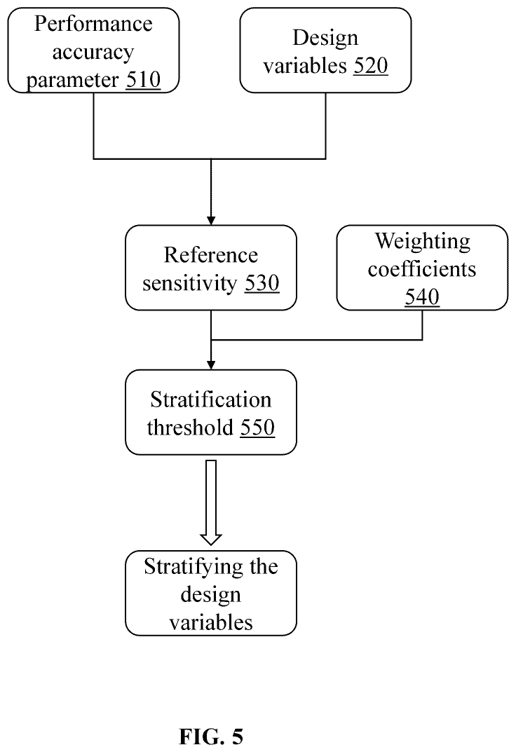

In some embodiments, the processor determines the stratification threshold based on a performance accuracy parameter and the weighting coefficients for the optimization objects, for more descriptions, please refer to FIG. 5.

In some embodiments, the processor utilizes the composite sensitivity to stratify the design variables to obtain the design variables of the first sensitivity layer and the design variables of the second sensitivity layer.

In some embodiments, the processor stratifies the design variables based on the composite sensitivity. For example, the processor substitutes the optimization objects and the design variables into Equation (2) to obtain calculation results.

According to the calculation results, it is determined that the design variables belonging to the first sensitivity layer (S_{com}(aᵢ)≥0.06) includes a₁, a₂, a₃, a₄, a₅, a₆, a₇, a₈, and a₉, and the design variables belonging to the second sensitivity layer (S_{com}(aᵢ)<0.06) includes a₁₀, a₁₁, and a₁₂.

In some embodiments, in response to the stratification threshold being different (e.g., the stratification threshold is not equal to 0.06), the design variables of the first sensitivity layer and the design variables of the second sensitivity layer are different from the stratification results described above.

Through the composite sensitivity analysis, the processor can effectively identify the influence of the design variables on the optimization objects. The design variables are divided into different sensitivity layers, and the optimization efficiency is improved by ranking each design variable according to its influence on the optimization objects.

More descriptions on a process for stratifying design variables can be found in FIG. 5.

S3: obtaining design variables corresponding to the optimal optimization object by processing the approximate model of the first sensitivity layer using the raccoon algorithm.

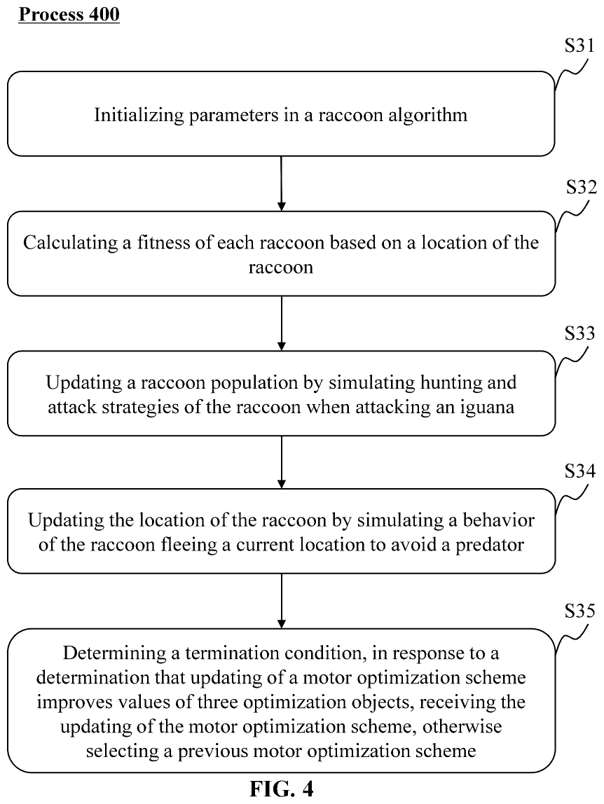

Compared with general algorithms, the raccoon algorithm has a strong ability to balance global search and local search during the search process and has high efficiency in dealing with various optimization problems and complex high-dimensional problems. High-speed convergence accelerates so that the average torque b₁, the torque pulsation b₂ and the cogging torque b₃ are all optimized. More descriptions on the raccoon algorithm can be found in FIG. 4.

The approximate model of the first sensitivity layer is a simplified mathematical model constructed for the design variables of the first sensitivity layer in order to reduce the amount of computation during the optimization process.

The optimal optimization object is a combination of maximizing average torque, minimizing torque pulsation, and minimizing the cogging torque to optimize the performance of the permanent magnet motor.

In some embodiments, the first sensitivity layer is fitted using a response surface model to obtain a relationship between the optimization objects and the design variables. The second sensitivity layer employs a single-parameter scan to optimize the design variables.

The response surface model refers to a model used to predict the change in the optimization objects with the design variables.

The single-parameter scan is a process of observing the effect of a change in one design variable on the optimization objects by independently changing that design variable (holding the other design variables constant). The composite sensitivity of each design variable to the optimization objects is determined based on the single-parameter scan, which in turn finds the design variable corresponding to the optimal optimization object.

The processor helps to improve the optimization efficiency by selecting the optimization objects and the design variables, and stratifying the design variables by combining the composite sensitivity. Additionally, using the raccoon algorithm to process the approximate model of the first sensitivity layer can quickly converge to the design variables corresponding to the optimal optimization object, and thus optimize the electromagnetic performance of the permanent magnet motor.

In some embodiments, a multi-objective optimization of the permanent magnet motor based on magnetic field modulation principle is performed by adopting a raccoon algorithm that has strong global and local search capabilities in the searching process and a high speed of convergence. Compared with general algorithms, the raccoon algorithm has high efficiency when dealing with various optimization problems as well as complex high-dimensional problems, and using the raccoon algorithm to obtain the optimal solution of the model can reduce the optimization workload and improve the optimization accuracy.

More descriptions on processing the approximate model of the first sensitivity layer using the raccoon algorithm can be found in FIG. 4.

FIG. 4 is a flowchart of an exemplary process for processing an approximate model of a first sensitivity layer using a raccoon algorithm according to some embodiments of the present disclosure. Process 400 includes the following steps and is performed by a processor.

S31: initializing parameters in the raccoon algorithm.

In some embodiments, the processor sets a population size N and a maximum count T of iterations in the raccoon algorithm, and based on a range of design variables and optimization objects, initializes a location of the raccoon population so that raccoons are evenly distributed in a search space.

In some embodiments, design variables of a first sensitivity layer form a 9-dimensional vector, the 9-dimensional vector is a design variable set, and each raccoon representing one design variable set. The population size N represents a count of the motor optimization schemes for each design variable set, and a design variable set is denoted by Equation (3) as:

$$a = {( {a}_{1} , {a}_{2} , {a}_{3} , {a}_{4} , {a}_{5} , {a}_{6} , {a}_{7} , {a}_{8} , {a}_{9} )}^{T} ; \qquad ( 3 )$$

The initial locations of all design variables set are represented by Equation (4) as follows:

$$P = [ \begin{matrix}{a}_{1 , 1} & … & {a}_{1 , j} & … & {a}_{1 , d} \\ ⋮ & & ⋮ & & ⋮ \\ {a}_{i , 1} & … & {a}_{i , j} & … & {a}_{i , d} \\ ⋮ & & ⋮ & & ⋮ \\ {a}_{N , 1} & … & {a}_{N , j} & … & {a}_{N , d}\end{matrix} ] ; \qquad ( 4 )$$

where N is a count of the motor optimization schemes for the design variables, in this embodiment, N takes A value of 100, d is a count of the design variables, in this embodiment, d takes a value of 9, a_{i,j} is an jth design variable of an ith the design variable set.

In some embodiments, the processor determines the design variable a_{i,j} via Equation (5).

$${a}_{i , j} = {lc}_{j} + r \cdot ( {uc}_{j} - {lc}_{j} ) , i = 1 , 2 , … , N , j = 1 , 2 , … , d ; \qquad ( 5 )$$

where a_{i,j} is the design variable, lc is a lower boundary of the jth design variable; ucⱼ is an upper boundary of the jth design variable, and (ucⱼ−lcⱼ) denotes a change range of the design variables, and r is a first random number.

In some embodiments, the lower boundary of the design variable, the upper boundary of the design variable, and the first random number are set by default by professional and technical personnel in design of the permanent magnet motor. For example, the upper boundary of the design variable a₁ is taken to be a value of 0.6, and the lower boundary is taken to be a value of 0.5. r is a random number in a range of 0 to 1. The values of the upper boundary of the design variable, the lower boundary of the design variable, and the first random number are determined based on the actual needs and are not restricted here.

By initializing the parameters in the raccoon algorithm, it is possible to ensure that the population size and the maximum count of iterations are set scientifically, as well as that the raccoon population is uniformly distributed in the search space. Additionally, each raccoon represents a design variable set, forming a multi-dimensional vector that enables efficient exploration of the motor optimization scheme. Thus, by restricting the design variables to a reasonable range, it helps to improve the global search capability of the raccoon algorithm and avoid local optimal solutions.

S32: calculating a fitness of each raccoon based on a location of the raccoon.

The fitness is a condition used to evaluate the strengths and weaknesses of the raccoon in the optimization process.

In some embodiments, the processor calculates the fitness of each raccoon by the following equation (6). The processor also computes the fitness based on any other feasible manner, which is not limited here. The processor substitutes the design variable values into a response surface model (e.g., a second-order response surface model), calculates the average torque, the torque pulsation, and the cogging torque corresponding to each design variable set, and calculates the fitness for each individual based on the response surface model, wherein the second-order response surface model is as follows:

$${y}_{l} = {β}_{0} + {\sum }_{i = 1}^{n} {β}_{i} {x}_{i} + {\sum }_{i = 1}^{n} {β}_{i i} {x}_{i}^{2} + {\sum }_{i = 1 , i < j}^{n} {β}_{i j} {x}_{i} {x}_{j} + ε \qquad ( 6 )$$

where yₗ is the fitness calculated based on the response surface modeling, n is the count of the design variables, xᵢ, xⱼ are the first ith, jth the design variables, β₀, βᵢ, βᵢᵢ and βᵢⱼ are regression coefficients, and ε is a statistical error. The regression coefficients and statistical errors are set by default by professional and technical staff.

S33: updating the raccoon population by simulating hunting and attack strategies of the raccoon when attacking an iguana.

The hunting refers to a search strategy in the raccoon algorithm, which is a process of finding potential motor optimization scheme.

The attack strategies are optimization strategies in the raccoon algorithm, i.e., a process of finding a motor optimization scheme with optimal performance.

The goal of the raccoon algorithm is to find a solution that maximizes the fitness function in the parameter space, i.e., to find a motor optimization scheme with optimal performance.

The iguana refers to a target of the raccoon algorithm, i.e., the motor optimization scheme with the best performance.

In some embodiments, N design variable sets may be updated by S 33.

In some embodiments, the processor first divides the raccoons into two parts, with the former part of the raccoons climbing a tree to hunt, and the latter part of the raccoons simulating attacking the iguana after the iguana randomly lands on the ground, and performs mathematically modeling on corresponding behaviors of the raccoons to express the behaviors using a mathematical expression to better find appropriate design variables. The locations of the raccoons represent different design variable sets, and the location of the iguana is the location of the best individual in the current raccoon population, i.e., a design variable set when all the optimization objects reach an optimal value optimization objects, and when all the optimization objects reach an optimal value, and when new locations of the raccoons improve values of the optimization objects, the corresponding design variable sets are updated and added to the motor optimization scheme, otherwise initial values of the motor optimization scheme are maintained.

In some embodiments, the N motor optimization schemes, i.e., the combination of the nine optimized design variables contained therein, are divided into two parts, the former and latter parts have an equal count of design variables of N/2.

In some embodiments, the processor determines the jth design variable of the ith design variable set in the former part is determined based on a jth design variable of a best design variable set in the current optimization scheme, a second random number, a jth design variable of a best design variable set in a current designed motor optimization scheme, by means of the following equation (7). The processor also determines, based on any other feasible means, the jth design variable of the ith design variable set in the former part, without limitation herein.

$${a}_{i , j}^{G} = {a}_{i , j} + r \cdot ( {Iguana}_{j} - I \cdot {a}_{i , j} ) \qquad ( 7 )$$

where

$${a}_{i , j}^{G}$$

is the jth design variable of the ith design variable set of the former part, Iguanaⱼ is the jth design variable of the best design variable set in the current motor optimization scheme, I is the second random number, e.g., I is a randomly selected integer in a range of {1, 2}, and

$${a}_{i , j}^{G}$$

is the jth design variable or the ith design variable set of the former part, r is the first random number, and a_{i,j} is a design variable.

In some embodiments, the processor is positively correlated with the lower boundary of the jth design variable based on the design variables in the latter part and negatively correlated with the change range of the design variables. Merely by way of example, the processor determines the design variables in the latter part through equation (8) below. The design variables for the latter part is the location of the best individual.

$${Iguana}_{j}^{t} = {lc}_{j} + r \cdot ( {uc}_{j} - l {c}_{j} ) \qquad ( 8 )$$

where

$${Iguana}_{j}^{t}$$

is the vector optimized by the designed permanent magnet motor, i.e., a combination of different design variables; lcⱼ is the lower boundary of the jth design variable; ucⱼ is the upper boundary of the jth design variable; (ucⱼ−lcⱼ) denotes the change range of the design variables, and r is the first random number.

By simulating the hunting and the attack strategies of a raccoon attacking an iguana, efficient optimization of the design variables can be achieved. The processor divides the raccoons into two phases, hunting and attacking, and efficiently updates the design variables by mathematically modeling the raccoon behavior. It is possible to ensure that when the raccoon's new location improves the values of the optimization objects, the corresponding design variables are updated and incorporated into the motor optimization scheme, otherwise the design variables remain at initial values. This improves the efficiency of the permanent magnet motor design and ensures the optimal value of the optimization objects.

S34: updating the location of the raccoon by simulating a behavior of the raccoon fleeing a current location to avoid a predator.

In some embodiments, to simulate the behavior of the raccoon fleeing the current location to avoid the predator, a random location is generated near the location where each raccoon is located. This step is to randomly generate a new design variable set near each design variable set, and if the new design variable set improves the value of the objective function, the design variable set is added into the motor optimization scheme, or else the design variable set is deleted.

In some embodiments, in response to a determination that updated design variables have a fitness less than a fitness of the design variables before updating, the processor may determine the motor optimization scheme for the former part as the jth design variable of the ith design variable set.

In some embodiments, in response to a determination that the updated design variables have a fitness greater than or equal to the fitness of the design variables before updating, the processor may determine the motor optimization scheme for the former part as locations of the updated design variables.

In some embodiments, the motor optimization scheme of the former part of the design variables (e.g., 50, etc.), i.e., random assignment of the design variable values, is characterized by the following equation (9). The processor also characterizes the motor optimization scheme of the former part based on any other feasible means, without limitation here.

$${a}_{i , j}^{G + 1} = \{ \begin{matrix}{a}_{i , j}^{G} , {F}_{i , j}^{G} < {F}_{i} \\ {a}_{i , j}^{G + 1} , else\end{matrix} \qquad ( 9 )$$

where

$${a}_{i , j}^{G + 1}$$

is the location of the updated design variable, Fᵢ is the fitness of the design variables before updating,

$${F}_{i , j}^{G}$$

is the fitness of the updated design variable, and a_{i,j}^{G} is the jth design variable of the ith design variables set in the former part of the design variables.

In some embodiments, in response to, in the three optimization objects, a maximum value of an average torque b₁, a minimum value of a torque pulsation b₂, and a minimum value of a cogging torque b₃ are less than function values corresponding to three initial optimization objects, respectively, the processor may determine optimized design variables in the latter part of the motor optimization scheme based on the jth design variable of the ith design variable set, a design variable set of the motor optimization scheme, the first random number, and the second random number.

In some embodiments, in response to, in the three optimization objects, the maximum value of the average torque b₁, the minimum value of the torque pulsation b₂, and the minimum value of the cogging torque b₃ are greater than or equal to the function values corresponding to the three initial optimization objects, respectively, the processor may determine jth dimension coordinates of the ith design variable set for updating the motor optimization scheme based on the jth design variable of the ith design variable set, a maximum boundary and a minimum boundary of the jth design variable in a current search space, and the first random number; wherein the motor optimization scheme has a boundary range less than or equal to a boundary range of the motor optimization scheme before updating.

In some embodiments, the optimized design variables in the latter part of the motor optimization scheme (e.g., 50, etc.) are characterized by the following equation (10). The processor also characterizes the optimized design variables in the latter part of the motor optimization scheme based on any other feasible means, which are not limited here.

$${a}_{i , j}^{t} = \{ \begin{matrix}{a}_{i , j} + r \cdot ( {Iguana}_{j}^{t} - I \cdot {a}_{i , j} ) , {F}_{{Iguana}^{t}} < {F}_{i}^{t} \\ {a}_{i , j} + r \cdot ( {a}_{i , j} - {Iguana}_{j}^{t} ) , else\end{matrix} \qquad ( 10 )$$

where

$${a}_{i , j}^{t}$$

denotes the jth design variable of the ith design variable set in the latter part; F_{Iguana}_{^{t}} denotes the maximum value of the average torque b₁, the minimum value of the torque pulsation b₂, and the minimum value of the cogging torque b₃ in the three optimization objects;

$${F}_{i}^{t}$$

denotes function values corresponding to the initial three optimization objects; r is the first random number; a_{i,j} is the design variable;

$${Iguana}_{j}^{t}$$

is the vector optimized by the designed permanent magnet motor.

In some embodiments, the updating of the motor optimization scheme is characterized by the following equation (11). The processor also updates the motor optimization scheme based on any other feasible means, which are not limited here.

$${a}_{i , j}^{G 1} = {a}_{i , j} + ( 1 - 2 r ) \cdot ( {lc}_{j}^{l o c a l} + r \cdot ( {uc}_{j}^{l o c a l} - l {c}_{j}^{l o c a l} ) ) \qquad ( 11 )$$

where

$${a}_{i , j}^{G 1}$$

is the jth design variable of the ith design variable set for the updating of the motor optimization scheme;

$$u {c}_{j}^{l o c a l} and {lc}_{j}^{l o c a l}$$

are a maximum boundary and a minimum boundary of the jth design variable in a current search space, and the boundary range of the design motor optimization scheme is less than or equal to the boundary range before updating; r is the first random number; a_{i,j} is the design variable.

The processor determines whether to update the design variables based on a fitness comparison result. The new location is used if the fitness is increased, otherwise the original location is kept. The optimization strategy is based on three objectives to ensure the convergence of the algorithm and the optimal solution of the design variables, and improve the design performance of the permanent magnet motor and the practicability of the algorithm.

S35: determining a termination condition, in response to a determination that updating of a motor optimization scheme improves values of three optimization objects, receiving the updating of the motor optimization scheme, otherwise selecting a previous motor optimization scheme.

In some embodiments, a count of iterations may be artificially selected, for example, the count of iterations is selected through two manners including selecting in a range of 100 and 500 or selecting by determine whether the motor optimization scheme has found the optimal value compared to the previous objective function value. When any of the two manners makes the output value no longer change, it is determined whether the maximum count of iterations has been reached or a scheme is found that makes the objective function value reach the optimal value.

The processor optimizes the design of the permanent magnet motor by initializing the parameters of the raccoon algorithm and updating the population location by simulating predation and evasion behavior. Updating the motor optimization scheme only when the optimization scheme improves the three target values, which improves the design efficiency and accuracy, and ensures that the performance of the permanent magnet motor is improved across the board.

FIG. 5 is an exemplary schematic diagram of stratifying design variables according to some embodiments of the present disclosure.

In some embodiments, the processor obtains a performance accuracy parameter 510 for optimization objects based on an input device, as shown in FIG. 5. The processor determines a reference sensitivity 530 based on the performance accuracy parameter 510 and design variables 520. The processor determines a stratification threshold 550 based on the reference sensitivity 530 and weight coefficients 540 of the optimization objects. The processor stratifies the design variables based on the stratification threshold 550.

The input device is a device for obtaining information and/or data. For example, the input device may include, but are not limited to, computers, programmable logic controllers, or the like.

The performance accuracy parameter is a maximum deviation in accuracy that can be accepted by an optimization objects of the permanent magnet motor.

In some embodiments, the performance accuracy parameter is set by a technician based on the needs of the scenario in which the permanent magnet motor is designed to be used.

In some embodiments of the present disclosure, according to that a performance accuracy parameter of a jth optimization object is positively correlated with an allowable machining error of the jth optimization object, and is negatively correlated with the jth optimization object, the processor also determines the performance accuracy parameter for the jth optimization object optimization object by means of the following equation (12).

$${P}_{j} = \frac{{T}_{j}}{{b}_{j}} \qquad ( 12 )$$

where Pⱼ is the performance accuracy parameter of the jth optimization object; Tⱼ is the allowable machining error of the jth optimization object; and bⱼ is the jth optimization object. Tⱼ, bⱼ is determined by professional and technical personnel through an a priori experiment.

The reference sensitivity is a sensitivity of each optimization object if the change that occurs does not affect the performance accuracy.

In some embodiments of the present disclosure, the processor determines the reference sensitivity based on the performance accuracy parameter and the design variable, in plurality of ways. For example, the processor first calculates a ratio of the amount Aat of change in the ith design variable to the ith design variable at, and then divides the performance accuracy parameter Pⱼ of the jth optimization object by the aforementioned ratio to obtain the reference sensitivity.

In some embodiments of the present disclosure, the processor determines a stratification threshold based on the reference sensitivity and the weighting coefficients in plurality of ways. For example, the processor determines the stratification threshold based on a weighted summation of absolute values of reference sensitivities based on the weighting coefficients. Merely by way of example, the stratification threshold is determined by the following equation (13).

$${S}_{c o m} ( 0 ) = {\sum }_{j = 1 , 2 , 3} {w}_{j} \vert S ( T ) \vert ; \qquad ( 13 )$$

where, S_{com}(0) is the stratification threshold; S(T) is the reference sensitivity; wⱼ is the weighting coefficients of the j optimization objects. The weighting coefficients are pre-set by professional and technical personnel, and merely by way of example, w₁, w₂ and w₃ are 0.5, 0.25 and 0.25, respectively.

More descriptions on the weighting coefficients can be found in FIG. 3 and FIG. 4.

In some embodiments of the present disclosure, in response to a composite sensitivity being less than a stratification threshold, the design variable corresponding to the composite sensitivity is a design variable of the second sensitivity layer. Conversely, the design variable is a design variable of the first sensitivity layer.

The processor analyzes performance accuracy parameters for the optimization objects obtained from the input device and determines the stratification threshold by combining the weighting coefficients of the optimization objects, which can accurately stratify the design variables and effectively identify the degree of influence of the different design variables on the optimization objects.

In some embodiments of the present disclosure, the processor obtains sensitivity distances among composite sensitivities of the design variables of the first sensitivity layer. The processor divides the design variables of the first sensitivity layer based on the sensitivity distances to obtain a plurality of first sensitivity sublayers. The processor obtains the design variables corresponding to the optimal optimization object by performing approximate model processing on the plurality of first sensitivity sublayers using the raccoon algorithm.

More descriptions on the design variables, the composite sensitivity, and the raccoon algorithm for the first sensitivity layer can be found in FIG. 3.

In some embodiments of the present disclosure, the processor arranges the plurality of the composite sensitivities in order of magnitude, calculates a difference between two adjacent composite sensitivities, and uses the difference as a sensitivity distance.

In some embodiments of the present disclosure, the processor calculates an average of the sensitivity distances to obtain a reference distance. In response to a determination that the sensitivity distance between two neighboring composite sensitivities exceeds the reference distance, a midpoint between the two composite sensitivities is used as a dividing boundary. Thus, the first sensitivity layer is divided into a plurality of first sensitivity sublayers.

In some embodiments of the present disclosure, the processor performs a single-parameter scanning optimization search on the design variables of the second sensitivity layer and executes the raccoon algorithm to optimize the first sensitivity layer.

In some embodiments of the present disclosure, when the processor optimizes the first sensitivity layer, a plurality of first sensitivity sublayers from strong to weak are obtained by sorting the first sensitivity sublayers based on the composite sensitivity of each first sensitivity sublayer to determine preferred combinations of the design variables of each first sensitivity sublayer. The preferred combinations of the design variables of each first sensitivity sublayer are collectively used as the design variables corresponding to the optimal optimization object of the first sensitivity layer. That is, by progressively optimizing each of the first sensitivity sublayers, it ensures that the optimization of each first sensitivity sublayer builds on the optimization of the previous first sensitivity sublayer.

The following is described merely by way of example. Assuming that the second sensitivity layers are a₁₀, a₁₁, a₁₂, and a₂; the first sensitive layer is divided into a plurality of sublayers according to the above manner, and the plurality of sublayers are sorted in order of composite sensitivity from strong to weak to obtain the first sensitive sublayer 1 includes a₁ and a₂, the first sensitive sublayer 2 includes a₃, a₄, a₅, and a₆; and the first sensitive sublayer 3 includes a₇, a₈, and a₉. The processor performs a single-parameter scanning optimization on the second sensitivity layer and optimizes the first sensitivity layer using the raccoon algorithm.

For example, S51, the first raccoon algorithm is used to optimize the design variables a₁˜a₉ in the first sensitivity layer and determine the preferred combinations of the design variables of the first sensitivity layer. S52, a second raccoon algorithm is used to optimize all the design variables in the first sensitivity layer, the preferred combinations of the design variables of a new first sensitive sublayer are determined, and the preferred combinations of the design variables of the first sensitive sublayer 3 in the previous process (S51) and the preferred combination values of the design variables of the first sensitive sublayer 2 determined in this iterative process (S52) are retained. S53, the third raccoon algorithm is used to optimize all the design variables in the first sensitivity layer, the preferred combinations of all the design variables for this iteration are determined, and the preferred combinations of the design variables of the first sensitive sublayer 2 and the preferred combinations of the design variables of the first sensitive sublayer 3 in the two preceding processes (S51 and S52) are replaced accordingly, thereby obtaining the design variables of the optimal optimization object corresponding to the first sensitivity layer.

In some embodiments, the first raccoon algorithm, the second raccoon algorithm, and the third raccoon algorithm are similar to the foregoing raccoon algorithm, with the difference being that a parameter used to perform the raccoon algorithm on each of the first sensitive sub-layers is different, and a count of optimized design variables is different.

By analyzing the composite sensitivity of the design variables in the first sensitivity layer and performing sublayer division through the processor, and using the raccoon algorithm to perform the approximate model processing on each sublayer, the accuracy and efficiency of the optimization object are improved, ensuring the optimal configuration of the design variables.

In some embodiments, the processor determines the parameters of the raccoon algorithm based on a count of the design variables to be determined and an average sensitivity of the design variables of a current first sensitivity sublayer.

The design variable to be determined is a design variable for which a preferred combination has not been determined. For example, the design variable to be determined is a design variable corresponding to a first sensitivity sublayer where the raccoon algorithm has not been performed.

In some embodiments, the processor determines the population size based on that a population size in the parameters of the raccoon algorithm (e.g., the first raccoon algorithm, the second raccoon algorithm, the third raccoon algorithm, etc.) is positively correlated with a count of design variables to be determined and the average sensitivity.

In some embodiments, the larger the count of design variables to be determined, the higher the problem dimensionality, and the greater the need for a larger population size to cover a broader search space. The higher the average sensitivity, the greater the impact of changes in the design variables on the optimization object, and the greater the need for the larger population size to improve the precision of the search.

In some embodiments, the processor determines the maximum count of iterations based on a positive correlation between the maximum count of iterations in the parameter and the count of design variables to be determined.

In some embodiments, when the count of design variables to be determined is greater, it is more difficult to search for the optimal solution, so the maximum count of iterations is increased to improve the ability to search for the optimal solution.

In some embodiments, the processor determines parameters of the response surface model in the current raccoon algorithm using an evaluation model based on the design variable to be determined, the composite sensitivity of the design variable to be determined, the optimization object, and the performance accuracy parameter of the optimization object; parameters of the response surface model include an order of the response surface model. The processor executes the current raccoon algorithm based on the parameters of the raccoon algorithm and the parameters of the response surface model.

The evaluation model is a machine learning model. For example, the evaluation model is any one or a combination of, for example, a deep neural network model, or other customized modeling structures, etc.

In some embodiments, the evaluation model is obtained by training based on a large number of first training samples with the first label. The processor inputs the plurality of first training samples with the first label into an initial evaluation model, constructs a loss function from the first label and results of the initial evaluation model, and iteratively updates the initial evaluation model based on the loss function. The model training is completed when predetermined conditions are satisfied, and a trained merged model is obtained. The preset conditions include that the loss function converges, a count of iterations reaches a threshold, and so on.

In some embodiments, the first training sample for training the evaluation model includes a count of sample determined design variables to be determined, a sample average sensitivity, a sample optimization object, and a sample performance accuracy parameter for the sample optimization object in historical sample data. The first label is a parameter of an actual response surface model, e.g., an order of the response surface model.

In some embodiments, in order to obtain a training dataset for the optimization algorithm of the permanent magnet motor, the processor optimizes the permanent magnet motor using a response surface model of varying orders and obtains an optimization result, which includes a plurality of finalized design variables. The processor performs testing based on the optimization result to obtain performance data of a finished permanent magnet motor. The processor takes the design variables, the sensitivity, the optimization object, and the performance accuracy parameters that need to be determined for the optimization as the first training samples, and selects parameters of a response surface model corresponding to an optimization result whose performance data most closely matches the optimization object as the first label. In some embodiments, the processor acquires a plurality of performance monitoring records of the optimized permanent magnet motor to obtain an actual value of the average torque, an actual value of the torque pulsation, and an actual value of the cogging torque of the permanent magnet motor during use. Based on the actual value of the average torque, the actual value of the torque pulsation, and the actual value of the cogging torque, a fitting degree of the response surface model is determined.

In some embodiments, the processor determines an incremental training set in response to the fitting degree being below a preset fitting threshold. The processor incrementally trains the evaluation model based on the incremental training set.

The performance monitoring records indicate performance of the permanent magnet motor in actual use. For example, the performance monitoring records are the same as specifics of the optimization object.

The fitting degree is a match degree between the value of the optimization object computed from parameters of the response surface model output by the evaluation model and the actual situation.

In some embodiments, the processor calculates a similarity between the fitness corresponding to the optimal optimized combination and the performance monitoring record, and determine the similarity as the fitting degree.

In some embodiments, the processor may supplement more training data as the incremental training set. The amount of training data in the incremental training set is negatively correlated with the fitting degree.

In some embodiments, the processor supplements additional training data as the incremental training set in accordance with the foregoing process of determining the first training sample.

By performing incremental training, the overfitting phenomenon of the evaluation model is reduced and the generalization ability of the evaluation model is improved.

The determination of the parameters of the raccoon algorithm helps to improve the efficiency and accuracy of the raccoon algorithm. The determination of the parameters of the response surface model through the machine learning models helps improve the efficiency of subsequent optimization.

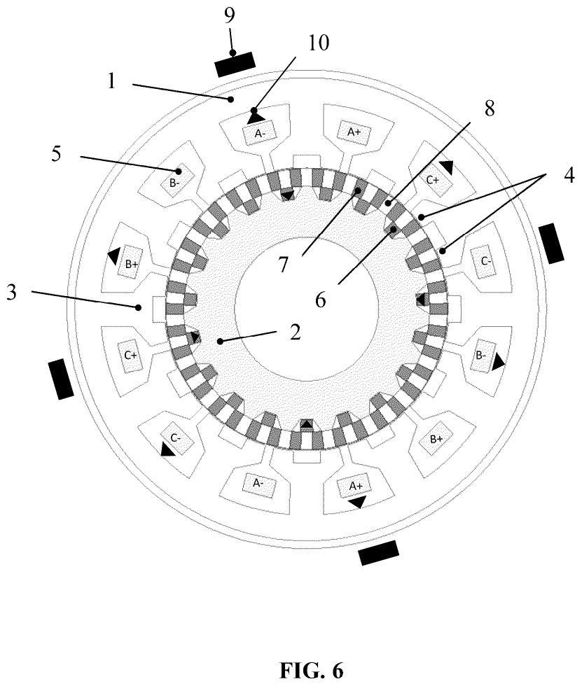

FIG. 6 is a schematic diagram of a structure of a temperature sensor and a temperature control unit according to some embodiments of the present disclosure.

In some embodiments, the permanent magnet motor includes a temperature sensor and a temperature control unit.

In some embodiments, a count of temperature sensors, a count of temperature control units, and deployment locations thereof in the permanent magnet motor are set based on actual needs, and are not limited herein. For example, as shown in FIG. 6, the permanent magnet motor includes a temperature sensor 9 and a temperature control unit 10. The deployment locations of the temperature sensor and the temperature control unit in FIG. 6 are for illustrative purposes only and are not limited herein.

More about a three-phase single layer centralized winding, a radial permanent magnet, and the spoke permanent magnets can be found in FIG. 1 and its related descriptions.

In some embodiments, the temperature sensors are distributed and uniformly deployed in the three-phase single layer centralized winding, the radial permanent magnet, and the spoke permanent magnets. The temperature sensors are configured to monitor temperature data at a plurality of points on the permanent magnet motor.

In some embodiments, the temperature control units are distributed and evenly deployed around the permanent magnet motor (e.g., at ends of two axes perpendicular to each other). The temperature control unit is configured to regulate temperature of the permanent magnet motor.

In some embodiments, the magnetic properties of a permanent magnet set decrease with increasing temperature. Elevated temperature may result in increased resistance of the three-phase single layer centralized winding, which affects the efficiency and output torque of the permanent magnet motor. Therefore, by deploying temperature sensors in a distributed manner in the three-phase single layer centralized winding, the radial permanent magnet, and the spoke permanent magnets, temperature monitoring at a plurality of points of the components in the permanent magnet motor may be implemented. Deploying the temperature control unit in a distributed manner around the permanent magnet motor helps regulate the temperature of the permanent magnet motor.

In some embodiments of the present disclosure, the processor obtains temperature data monitored by the temperature sensor.

The temperature data includes temperature data from a plurality of points on the permanent magnet motor.

In some embodiments of the present disclosure, the temperature data further includes interpolated temperature data.

The interpolated temperature data is predicted temperature data for the insertion point.

The insertion point is a point where a distributed temperature sensor is not deployed. For example, the insertion point includes a point on the surface of the permanent magnet motor, a point within the motor material, or the like.

In some embodiments of the present disclosure, the processor obtains the insertion point in a plurality of ways. For example, the processor divides the permanent magnet motor as a whole into a plurality of grids, and centers of the grids in which the distributed temperature sensor is not deployed are used as insertion points.

In some embodiments of the present disclosure, the processor predicts the interpolated temperature data of the insertion point based on the insertion point, the temperature data, the design variables of the optimal optimization object, material parameters of the permanent magnet motor, and operating parameters through a temperature evaluation model.

The material parameters include, but are not limited to, a type number, a dimension, etc., of the material.

The operating parameters include, but are not limited to, a voltage, a current, and a speed of the permanent magnet motor.

In some embodiments of the present disclosure, the temperature evaluation model is a machine learning model. For example, the temperature evaluation model is any one or a combination of a recurrent neural network model or other customized modeling structures.

In some embodiments of the present disclosure, the temperature evaluation model is obtained by training based on a large number of second training samples with a second label. The temperature evaluation model is trained in a similar manner as the evaluation model, referring to FIG. 5.

In some embodiments of the present disclosure, the second training sample for training the temperature evaluation model includes a sample insertion point, sample temperature data, sample design variables of a sample optimal optimization object, sample material parameters of a sample permanent magnet motor, and sample operating parameters of the sample permanent magnet motor in historical sample data. The second label is actual interpolated temperature data.

In some embodiments of the present disclosure, the processor experimentally obtains temperature data of the permanent magnet motor under different operating parameters and load conditions for training the temperature evaluation model. During the experiment, the processor selects different permanent magnet motors, sets different operating parameters and load conditions, suspends the operation of the permanent magnet motors at different time points, and uses an infrared temperature detector to measure and characterize the overall temperature of the permanent magnet motors (e.g., in the form of a heat map, etc.).

In some embodiments of the present disclosure, the processor may use the temperature data of the point where the distributed temperature sensors are deployed, the insertion points, the temperature data, the design variables of the optimal optimization object, the material parameters, and the operating parameters as the second training sample. The processor will use the temperature data of the insertion point locations as the second label.

By predicting the interpolated temperature data through the temperature evaluation model, the problem that the internal temperature of the permanent magnet motor cannot be directly monitored is effectively solved. Scaling down the count of temperature sensors not only reduces the interference to the operation of the permanent magnet motor, but also ensures the accuracy of the temperature prediction at key points, improving the performance evaluation and operational reliability of the permanent magnet motor.

In some embodiments of the present disclosure, the processor determines a temperature control parameter based on the temperature data in response to the temperature data satisfying a cooling condition.

The cooling condition includes temperature data at at least one point exceeding a preset temperature threshold. The preset temperature threshold is set by a technician or system default.

The temperature control parameter is a parameter for cooling down the permanent magnet motor. For example, the temperature control parameter includes a cooling power, a cooling duration, and so on.

In some embodiments of the present disclosure, the processor determines a temperature control parameter based on the temperature data by a variety of ways. For example, the processor determines the temperature control parameter based on a heating speed during a preset time period by querying a temperature control parameter table. The temperature control parameter table is obtained based on a test, and the test includes that, at different heating speeds, the temperature control unit cools down the temperature based on different temperature control parameters. The temperature control parameter that cools down the temperature with the best effect is recorded as the temperature control parameter corresponding to that heating speed in the temperature control parameter table.

In some embodiments of the present disclosure, the processor controls the temperature control unit to cool the permanent magnet motor based on the temperature control parameter.

By monitoring the temperature of the permanent magnet motor in real time, the processor can detect overheating problems in a timely manner, avoiding damage to the device or degradation of performance due to high temperatures.

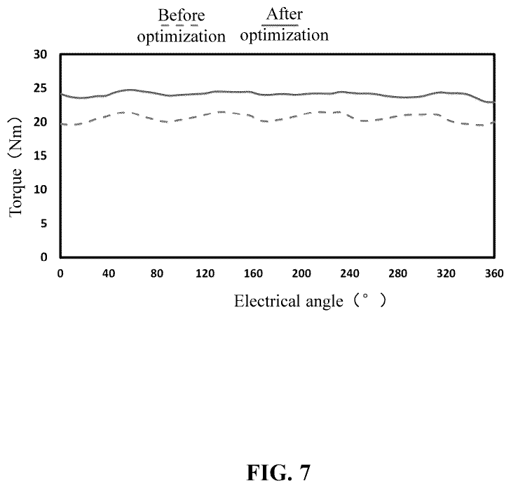

Simulation of the optimized permanent magnet motor is performed, and the simulation results are shown in FIG. 7-FIG. 9 below.

FIG. 7 is a comparative waveform graph of a motor torque according to some embodiments of the present disclosure.

In some embodiments of the present disclosure, as shown in FIG. 7, an average torque of a permanent magnet motor before optimization is 19.5 Nm, and an average torque of the permanent magnet motor after optimization is 23.8 Nm, which increases by 22.05%. By comparing the smoothness of the output torque waveforms, it can be seen that the permanent magnet motor after optimization has a less torque pulsation and a higher average torque.

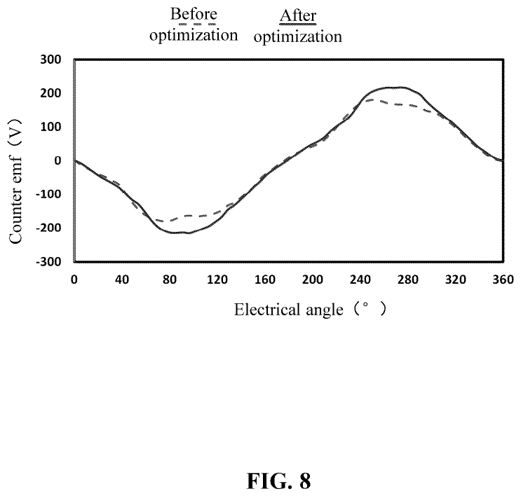

FIG. 8 is a comparative waveform graph of a no-load back electromotive force of a motor according to some embodiments of the present disclosure.

As shown in FIG. 8, waveforms of the A-phase no-load back electromotive force of the permanent magnet motor before optimization and after optimization are provided, and an amplitude of the A-phase no-load back electromotive force of the permanent magnet motor after optimization is about 21.6 V. The amplitude of the A-phase no-load back electromotive force of the permanent magnet motor before optimization is about 19.5 V. The amplitude of back electromotive force is improved by about 11%, which indicates that the performance of the permanent magnet motor is significantly improved after optimization with the raccoon algorithm in the present disclosure.

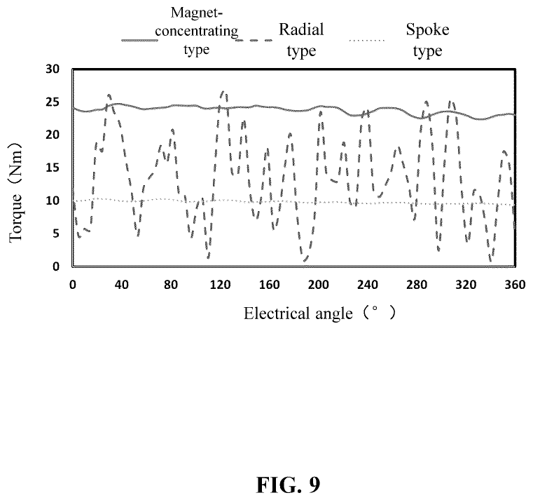

FIG. 9 is a comparative waveform graph of a torque of a magnet-concentrating permanent magnet unit according to some embodiments of the present disclosure.

In some embodiments of the present disclosure, as shown in FIG. 9, a torque amplitude of the magnet-concentrating permanent magnet unit proposed herein is greater than that of a radial permanent magnet motor and a spoke permanent magnet motor, while the torque pulsation of the magnet-concentrating permanent magnet unit is significantly lower than that of the latter two.

It should be understood that the embodiments described in the present disclosure are only used to illustrate the principles of the embodiments of the present disclosure. Other deformations also fall within the scope of the present disclosure. Therefore, alternative configurations of embodiments of the present disclosure are viewed as consistent with the teachings of the present disclosure as an example, not as a limitation. Correspondingly, the embodiments of the present disclosure are not limited to the embodiments expressly presented and described herein.

What is claimed is:

1. A permanent magnet motor based on magnetic field modulation principle, comprising a stator and a rotor, wherein the rotor is disposed on an inner side of the stator, the stator is rotationally connected to the rotor, at least one armature tooth is disposed on the inner side of the stator, a three-phase single layer centralized winding is disposed on the at least one armature tooth, at least one rotor slot wedge is disposed on the outer side of the rotor, rotor teeth are disposed on a top of the at least one rotor slot wedge, rotor slots are disposed between the rotor teeth, a permanent magnet set is disposed in each of the rotor slots, at least two stator modulating teeth are disposed on a top of the armature tooth, and a stator slot is disposed between adjacent stator modulating teeth in the at least two stator modulating teeth.

2. The permanent magnet motor of claim 1, wherein in each of the rotor slots, the permanent magnet set includes a radial permanent magnet and two spoke permanent magnets, the radial permanent magnet is disposed at a bottom of the rotor slot, the two spoke permanent magnets are respectively disposed on both sides of the radial permanent magnet, the two spoke permanent magnets are fixedly connected to a side wall of the rotor slot; the spoke permanent magnets are tangentially magnetized permanent magnets, the two spoke permanent magnets are magnetized in opposite directions, and the radial permanent magnet is an axially magnetized permanent magnet.

3. The permanent magnet motor of claim 2, wherein a count of pole pairs of the permanent magnet set, a count of pole pairs of an armature winding set, and a count of the stator modulating teeth satisfy a preset correspondence relationship.

4. An optimization system, comprising a permanent magnet motor and a processor, the permanent magnet motor being communicatively connected to the processor; wherein:
the permanent magnet motor includes a stator and a rotor, wherein the rotor is disposed on an inner side of the stator, the stator is rotationally connected to the rotor, at least one armature tooth is disposed on the inner side of the stator, a three-phase single layer centralized winding is disposed on the at least one armature tooth, at least one rotor slot wedge is disposed on the outer side of the rotor, rotor teeth are disposed on a top of the at least one rotor slot wedge, rotor slots are disposed between the rotor teeth, a permanent magnet set is disposed in each of the rotor slots, at least two stator modulating teeth are disposed on a top of the armature tooth, and a stator slot is disposed between adjacent stator modulating teeth in the at least two stator modulating teeth; and
the processor is configured to:
select optimization objects and design variables based on the permanent magnet motor;
obtain design variables of a first sensitivity layer and design variables of a second sensitivity layer by stratifying the design variables using a composite sensitivity; wherein each of the design variables of the first sensitivity layer has a composite sensitivity greater than or equal to a stratification threshold, and each of the design variables of the second sensitivity layer has a composite sensitivity less than the stratification threshold; and
obtain design variables corresponding to an optimal optimization object by processing an approximate model of the first sensitivity layer using a raccoon algorithm.

5. The optimization system of claim 4, wherein the optimization objects include an average torque b₁, a torque pulsation b₂, and a cogging torque b₃;
the design variables include a ratio a₁ of an opening height of the stator slot to a height of the stator slot, a ratio a₂ of a height of each of the stator modulating teeth to the height of the stator slot, a ratio a₃ of an opening width of the stator slot to a width of the stator slot, a ratio a₄ of a width of each of the stator modulating teeth to the width of the stator slot, an opening width a₅ of each of the rotor slots, a pole arc coefficient a₆ of the radial permanent magnet, a height a₇ of the radial permanent magnet, a pole arc coefficient a₈ of each of the spoke permanent magnets, a height a₉ of each of the spoke permanent magnets, an opening height a₁₀ the rotor slot, a height a₁₁ of the rotor slot wedge, and a ratio a₁₂ of the opening width of the rotor slot to a bottom width of the rotor slot.

6. The optimization system of claim 5, wherein the processor is further configured to:
determine a sensitivity based on the optimization objects and the design variables; determine the composite sensitivity based on the sensitivity, the optimization objects, and weighting coefficients of the optimization objects; and
stratify the design variables based on the composite sensitivity; wherein the design variables of the first sensitivity layer include a₁, a₂, a₃, a₄, a₅, a₆, a₇, a₈, and a₉, and the design variables of the second sensitivity layer include a₁₀, a₁₁, and a₁₂.

7. The optimization system of claim 6, wherein the processor is further configured to:
obtain load feature data for the optimization objects;
determine a correlation coefficient between the optimization objects and the design variables based on the load feature data for the optimization objects; and
determine the weighting coefficients of the optimization objects based on the correlation coefficient.

8. The optimization system of claim 4, wherein the processor is further configured to:
initialize parameters in the raccoon algorithm;
calculate a fitness of each raccoon based on a location of the raccoon;
update a raccoon population by simulating hunting and attack strategies of the raccoon when attacking an iguana;
update the location of the raccoon by simulating a behavior of the raccoon fleeing a current location to avoid a predator; and
determine a termination condition, in response to a determination that updating of a motor optimization scheme improves values of three optimization objects, receive the updating of the motor optimization scheme, otherwise select a previous motor optimization scheme.

9. The optimization system of claim 8, wherein the processor is further configured to:
set a population size N and a maximum count T of iterations in the raccoon algorithm, initialize, based on a range of the design variables and the optimization objects, a location of the raccoon population, so that raccoons are distributed in a search space; wherein
the design variables of the first sensitivity layer form a 9-dimensional vector, the 9-dimensional vector is a design variable set, each raccoon represents one design variable set, the population size N represents a count of motor optimization schemes for each design variable set, the design variable set is denoted as:
$$a = {( {a}_{1} , {a}_{2} , {a}_{3} , {a}_{4} , {a}_{5} , {a}_{6} , {a}_{7} , {a}_{8} , {a}_{9} )}^{T} ;$$
initial locations of all design variable sets are denoted as:
$$P = [ \begin{matrix}{a}_{1 , 1} & … & {a}_{1 , j} & … & {a}_{1 , d} \\ ⋮ & & ⋮ & & ⋮ \\ {a}_{i , 1} & … & {a}_{i , j} & … & {a}_{i , d} \\ ⋮ & & ⋮ & & ⋮ \\ {a}_{N , 1} & … & {a}_{N , j} & … & {a}_{N , d}\end{matrix} ] ;$$
wherein N is the count of motor optimization schemes for each design variable set, d is a count of the design variables, a_{i,j} is a jth design variable of an ith design variable set, and a_{i,j} is determined based on a lower boundary of the jth design variable, an upper boundary of the jth design variable, a change range of the design variables, and a first random number.

10. The optimization system of claim 9, wherein the processor is further configured to:
divide raccoons into two parts, with a former part simulating raccoon hunting and a latter part simulating raccoon attacking after the iguana is randomly landed on the ground, and perform mathematically modeling based on behaviors corresponding to the raccoons;
wherein locations of the raccoons represent different design variable sets, a location of the iguana is a location of best individual in a current raccoon population, the location of the iguana represents a design variable set when all the optimization objects reach an optimal value, and when new locations of the raccoons improve values of the optimization objects, the corresponding design variable sets are updated and added to the motor optimization scheme, otherwise initial values of the motor optimization scheme are maintained;
divide the motor optimization scheme into two parts, the former and latter parts have an equal count of design variables of N/2, wherein:
the jth design variable of the ith design variable set in the former part is determined based on a jth design variable of a best design variable set in the current optimization scheme, a second random number, a jth design variable of a best design variable set in a current designed motor optimization scheme; and
the design variables of the latter part are determined based on the lower boundary of the jth design variable, the upper boundary of the jth design variable, the change range of the design variables, and the first random number.

11. The optimization system of claim 10, wherein the processor is further configured to:
in response to a determination that updated design variables have a fitness less than a fitness of the design variables before updating, determine the motor optimization scheme for the former part as the jth design variable of the ith design variable set; in response to a determination that the updated design variables have a fitness greater than or equal to the fitness of the design variables before updating, determine the motor optimization scheme for the former part as locations of the updated design variables;
in response to, in the three optimization objects, a maximum value of an average torque b₁, a minimum value of a torque pulsation b₂, and a minimum value of a cogging torque b₃ are less than function values corresponding to three initial optimization objects, respectively, determine optimized design variables in the latter part of the motor optimization scheme based on the jth design variable of the ith design variable set, a design variable set of the motor optimization scheme, the first random number, and the second random number; and
in response to, in the three optimization objects, the maximum value of the average torque b₁, the minimum value of the torque pulsation b₂, and the minimum value of the cogging torque b₃ are greater than or equal to the function values corresponding to the three initial optimization objects, respectively, determine jth dimension coordinates of the ith design variable set for updating the motor optimization scheme based on the jth design variable of the ith design variable set, a maximum boundary and a minimum boundary of the jth design variable in a current search space, and the first random number; wherein the motor optimization scheme has a boundary range less than or equal to a boundary range of the motor optimization scheme before updating.

12. The optimization system of claim 4, wherein the processor is further configured to:
obtain a performance accuracy parameter for the optimization objects based on an input device;
determine a reference sensitivity based on the performance accuracy parameter and the design variables;
determine the stratification threshold based on the reference sensitivity and weighting coefficients of the optimization objects; and
stratify the design variables based on the stratification threshold.

13. The optimization system of claim 12, wherein the processor is further configured to:
obtain sensitivity distances among composite sensitivities of the design variables of the first sensitivity layer;
divide the design variables of the first sensitivity layer based on the sensitivity distances to obtain a plurality of first sensitivity sublayers; and
obtain the design variables corresponding to the optimal optimization object by performing approximate model processing on the plurality of first sensitivity sublayers using the raccoon algorithm.

14. The optimization system of claim 13, wherein the processor is further configured to:
determine parameters of the raccoon algorithm based on a count of design variables to be determined, and an average sensitivity of the design variables of a current first sensitivity sublayer;
determine parameters of a response surface model in a current raccoon algorithm using an evaluation model based on the design variables to be determined, a composite sensitivity of the design variables to be determined, the optimization objects, and the performance accuracy parameter of the optimization objects, the evaluation model being a machine learning model; and
execute the current raccoon algorithm based on the parameters of the raccoon algorithm and the parameters of the response surface model.

15. The optimization system of claim 14, wherein the processor is further configured to:
obtain a plurality of performance monitoring records of an optimized permanent magnet motor, obtain an actual value of the average torque, an actual value of the torque pulsation, and an actual value of the cogging torque of the permanent magnet motor when in use;
determine a fitting degree of the response surface model based on the actual value of the average torque, the actual value of the torque pulsation, and the actual value of the cogging torque;
determine an incremental training set in response to the fitting degree being below a preset fitting threshold; and
incrementally train the evaluation model based on the incremental training set.

16. The optimization system of claim 4, wherein in each of the rotor slots, the permanent magnet set includes a radial permanent magnet and two spoke permanent magnets, the radial permanent magnet is disposed at a bottom of the rotor slot, the two spoke permanent magnets are respectively disposed on both sides of the radial permanent magnet, the two spoke permanent magnets are fixedly connected to a side wall of the rotor slot; the spoke permanent magnets are tangentially magnetized permanent magnets, the two spoke permanent magnets are magnetized in opposite directions, and the radial permanent magnet is an axially magnetized permanent magnet.

17. The optimization system of claim 16, wherein the permanent magnet motor further includes a temperature sensor and a temperature control unit, the temperature sensor is deployed in the three-phase single layer centralized winding, the radial permanent magnet, and the spoke permanent magnets, the temperature sensor is configured to monitor temperature data at a plurality of points on the permanent magnet motor; the temperature control unit is deployed around the permanent magnet motor, and the temperature control unit is configured to regulate temperature of the permanent magnet motor.

18. The optimization system of claim 17, wherein the processor is further configured to:
obtain temperature data monitored by the temperature sensor;
determine a temperature control parameter based on the temperature data in response to the temperature data satisfying a cooling condition; and
control the temperature control unit to cool the permanent magnet motor based on the temperature control parameter.

19. The optimization system of claim 18, wherein the temperature data includes insertion temperature data, and the processor is further configured to:
predict insertion temperature data at an insertion point using a temperature evaluation model based on the insertion point, the temperature data, the design variables of the optimal optimization object, and a material parameter and an operating parameter of the permanent magnet motor; the temperature evaluation model being a machine learning model.
